(19) United States
(12) Patent Application Publication
(10) Pub. No.: US 2008/0102217 A1
(43) Pub. Date: May 1, 2008

(54) PROCESS FOR ANTI-MICROBIAL TEXTILES TREATMENT

(76) Inventor: Yu-Te Lin, Taipei City (TW)

Correspondence Address: LEONG C LEI, PMB # 1008, 1867 YGNACIO VALLEY ROAD, WALNUT CREEK, CA, 94598, US

(21) Appl. No.: 11/555,285

(22) Filed: Nov. 1, 2006

(51) Int. Cl. B05D 3/02

(52) U.S. Cl. 427/389.9

(57) ABSTRACT

A process for anti-microbal textile treatment which provides durable and anti-microbial textiles and methods for preparing same. Such textiles can be readily prepared using a wet curing process to covalently attach a Complex Formula Compounds to a cellulose based material or other polymeric material. Once prepared, the textiles of the present invention have a broad spectrum of biocide activity against pathogenic microorganisms, and durability and efficacy of the antimicrobial properties.

### BACKGROUND OF THE INVENTION

Antimicrobial materials such as fabrics, polymers and even children's toys have become increasingly popular due to public concerns over epidemiological diseases and pathogens. With respect to antimicrobial fabrics, domestic and international markets have grown significantly as a result of public awareness of these potential threats. Antimicrobial clothing can be used in medicine as well as other institutional uses for such applications as, surgeon's gowns, caps, masks, patient drapes, bandages, wipers and cover cloths of various sizes.

An important and growing part of the textile industry is the medical and related healthcare and hygiene sectors. Textile materials used in medical-related applications include, for example, surgeon's gowns, caps and masks, patient drapes, bandages, wipers and cover cloths of various sizes. Such textile materials, however, are conductive to cross-infection and transmission of diseases caused by microorganisms. As such, the possibility of spreading infections caused by the lethal HIV virus, the insidious hepatitis virus or other epidemic diseases has created an increased concern regarding the use of protective facilities and uniforms for workers in the medical/healthcare/hygiene sectors.

Although the demand for antimicrobial textile materials is high, few of such textiles are available, especially ones that are effective against a broad spectrum of bacteria and, which are effective after multiple machine washes. Research and development of durable functional textiles has been active in recent years, with new methods of incorporating antibiotics as bactericidal agents into textiles, polymers being advanced.

However, most of the antimicrobial functions have been achieved by using a slow-releasing model. This model works by leaching the biocidal active agent to the surface of the material thereby inactivating the microorganisms. However, this method limits the durability of the biocidal property.

Currently, textile materials used in medical applications are disposable, no woven synthetic fabrics which are neither biocidal nor reusable. Such textile fabrics provide protection by blocking the transmission of microorganisms, rather than by inhibiting the growth of the microorganisms. Thus, cross-infection through surface contact of the contaminated textile fabrics is problematic.

As a result, in an effort to prevent the cross-infection and transmission of diseases, the contaminated materials must be appropriately sterilized and discarded after use. Unfortunately, such sterilization and discarding procedures result in substantial increases in the cost of healthcare and in the amount of bio-hazardous wastes that are generated.

In some invention, describes durable and regenerable cellulose materials by using an innovative chemical finishing method. In that invention, treatment of cotton and polyester/cotton fabrics were finished by hydantoin derivatives, and owning biocidal properties by washing the treated fabrics with a chlorine laundry bleach. Chlorination of amide and imide bonds in hydantoin rings produce biocidal properties. The hydantoin return to their precursor forms when the sites are exposed to microorganisms. And have no biocidal properties, until the textiles be regenerated by using chlorine bleach.

Hydantoin chemistry however, is not applicable to fabrics. The use of chlorine bleach decolorizes textiles. Thus, a non-bleach agent Complex Formula Compounds would be desirable for all applications, especially for colored materials. Ideally for economic and convenience reasons, a process for preparing a anti-microbial cellulose textile with a Complex Formula Compounds could be designed.

Accordingly, it is desirable that bacterial infections resulting from contact with contaminated textiles be reduced or eliminated, and that transmission of pathogenic bacteria from person to person during wear or use of contaminated textiles is prevented by inhibiting the growth of the microorganisms on fabrics. Moreover, it is desirable that surgeon's dresses, hospital carpeting and bedding materials, underwear, socks, and uniforms be biocidal so as to provide the best protection possible.

Currently, there are two general categories of technologies which can provide protection for medical/healthcare/hygiene personnel. They are (1) physical techniques which involve the formation of a physical barrier against microbial infiltration or transmission by selecting fabric constructions and coating that are impermeable or that are micro porous and contain antimicrobial agents; and

(2) chemical technologies which involve the incorporation of active functional agents onto fabrics or fibers by grafting or other chemical methods. Disposable materials are examples of the first category. The coating method involves the application of impermeable materials onto the surface of fabrics, thereby blocking the infiltration and permeation of microorganisms. However, cross-infection and spreading of diseases through the contact of the coating surface is still feasible and, thus, pose potential threats to workers who handle the contaminated materials. Moreover, the impermeable properties can cause wearers to become uncomfortable and, in turn, to become less efficient in their.

As such, the chemical association of antibacterial agents onto either the surface or entirety of the material appears to be more practical in terms of durability and efficacy of the antibacterial properties. There are two major pathways to chemically achieve durable antibacterial effects.

In one pathway, the slow-releasing of biocides through contact with the processed fabrics is employed. In this pathway, a pathway widely used around the world, sufficient chemical agents are impregnated onto the fibers by either chemical or physical methods. Thereafter, the biocides are slowly released from the processed fabrics into the media, thereby contacting and inhibiting the growth of microorganisms. Unfortunately, such chemical agents can be washed away easily if they are not covalently impregnated onto the surface of the fabrics. Moreover, the antibacterial functions are non-regenerable.

In the second pathway, a more innovative technology is employed which involves chemical modification of textile materials with biocidal or potential biocidal compounds, wherein the antibacterial properties of such compounds are regenerable with a simple washing. The potential antibacterial groups can be rendered biocidal after washing with certain common chemicals, such as diluted bleaching solutions.

In this present inventors, Formular-A (Chitosan and chitin) are polysaccharide polymers containing more than 5,000 glucosamine and acetylglucosamine units, respectively, and their molecular weights are over one million Daltons. Chitin is found in fungi, arthropods and marine invertebrates. Commercially, chitin is derived from the exoskeletons of crustaceans (shrimp, crab and other shellfish). Chitosan is obtained from chitin by a deacetylation process.

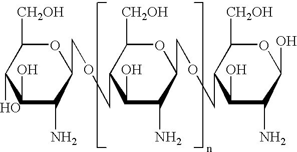

### Chitosan

Chitosan is used mostly applied in textile, they are covalently impregnated onto the surface of the fabrics. Depending on the different viscosity, in particular, chitosan owing to the characters naturally activating capability without virulent and side effect, absorbed in body, reducing heavy metal, adjusting PH in body, occurring, and expelling heavy metal out of body, is greatly applied as the food protecting health and the medicine additive.

Formula-B is a member selected from the group consisting of Hydantoin chemistry, Heterocyclic N-halamine, and quaternary ammonium salt.

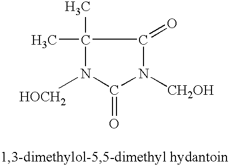

Hydantoin chemistry, Heterocyclic N-halamine is a member selected from the group consisting of “Heterocyclic N-halamine,” as used herein, refers to a 4- to 7-membered ring, wherein at least 3 members of the ring are carbon, and from 1 to 3 members of the ring are nitrogen heteroatom, and from 0 to 1 member of the ring is oxygen heteroatom, wherein from 0 to 2 carbon members comprise a carbonyl group, and wherein at least 1 to 3 nitrogen atoms are substituted with a hydrogen or hydroxyalkyl group, such as —CH.sub.2 OH, or a alkoxyalkyl group, such as —CH.sub.2 OCH.sub3. At least one ring nitrogen has bonded thereto a halogen atom. In addition, the ring members can be further substituted with alkyl groups, such as methyl, ethyl, etc., or hydroxy groups. Heterocyclic N-halamines are generally disclosed in U.S. Pat. No. 5,490,983 issued to Worley, et al. on Feb. 13, 1996, the teachings of which are incorporated herein by reference for all purposes.

And quaternary ammonium salt is a member selected from the group consisting of:
dodecyltrimethyl ammonium bromide,
N-(3-chloro-2-hydroxypropyl)-N,N-dimethyldodecylammonium chloride,
1,3-Bis-(N,N-dimethyldodecylammonium chloride)-2-propanol,
dodecyltrimethyl ammonium chloride,
N-(1-(2,3-dioleoyloxy)propyl)-N,N,N-trimethylammonium chloride,
N-(1-(2,3-dioleyloxy)propyl)-N,N,N-trimethylammonium chloride,
dimethyldioctadecyl ammonium bromide,
N,N-dioleyl-N,N-dimethylammonium chloride and
1,2-dioleoyloxy-3-(N,N,N-trimethylamino)propane chloride.

In view of the foregoing, there exists a need in the art for durable and non-regenerable need anti-microbial textiles. The present invention remedies such need by providing, Complex Formula Compounds durable anti-microbial polymers and textiles.

Two commercially available heterocyclic compounds with same active moieties have been applied on cotton and cotton containing materials. These compounds are soluble in water, so an aqueous finishing process is adopted. The chemicals were padded on fabrics, and then dried and cured at elevated temperatures. The biocidal properties of finished cotton fabrics have been evaluated against Escherichia coli, and Staphylococcus aureus mainly. Qualitative biocidal tests of the research have been summarized in a conference proceeding.

### SUMMARY OF THE INVENTION

The primary purpose of the present invention is to provides durable and anti-microbial textiles and methods for preparing same. Such textiles can be readily prepared using a classical wet curing process to covalently attach a Complex Formula Compounds to a cellulose based material or other polymeric material. Once prepared, the textiles of the present invention have a broad spectrum of biocide activity against pathogenic microorganisms, and durability and efficacy of the antimicrobial properties.

In one embodiment, the present invention provides a process for preparing a microbiocidal cellulose, cellulose/polyester or polyester textile precursor, the process comprising:
(a) Wetting a cellulose textile in an aqueous treating solution which comprises a anti-microbial Complex Formula Compound
(b) Dewatering the excess treating solution from said cellulose textile;
(c) curing said dried cellulose textile;
(d) washing said cured cellulose textile to remove excess reagents;
(e) drying said cellulose textile to remove water; and thereby preparing a anti-microbial cellulose textile.

There are a myriad of applications areas for the Anti-microbial textiles of the present invention. For instance, Anti-microbial textile materials can provide biocidal protective clothing to personnel in the medical area as well as in the related healthcare and hygiene area.

In contrast to previously used textiles, the textiles of the present invention are not a barrier to microorganisms, but a disinfectant to them. As such, the reusable biocidal materials can replace currently used disposable, no woven fabrics as medical textiles, thereby significantly reducing hospital maintenance costs and disposal fees. The anti-microbial properties of the textiles of the present invention can be advantageously used for women's wear, underwear, socks, and other hygienic purposes. In addition, the anti-microbial properties can be imparted to paper or carpeting materials to create odor-free and germ-free carpets. Moreover, all germ-free environments, such as required in biotechnology and pharmaceutical industry, would benefit from the use of the anti-microbial textiles of the present invention to prevent any contamination from air, liquid, and solid media.

Other features, objects and advantages of the invention and its preferred embodiments will become apparent from the detailed description which follows.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates examples of Chitosan which are suitable for use in the present invention, as the Complex Formula-A

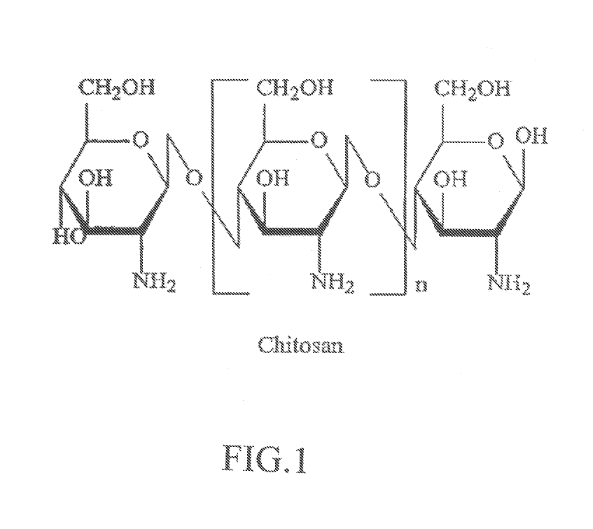

FIG. 2 illustrates examples of 1,3-dimethylol-5,5-dimethylhydantoin (DMDMH), which are suitable for use in the present invention, as the Complex Formula-B.

FIG. 3 illustrates the reaction scheme whereby the Complex Formula-A and Formula-B is covalently attached to cellulose.

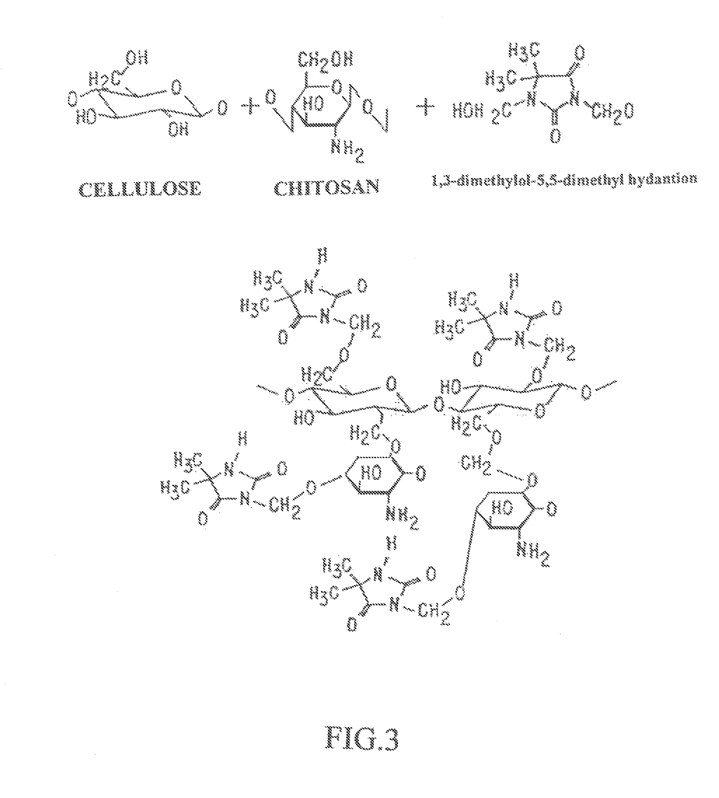

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In one embodiment, the present invention provides a process for preparing a Anti-microbial cellulose, cellulose/polyester or polyester textile, the process comprising:
(a) Wetting a cellulose textile in an aqueous treating solution which comprises a anti-microbial Complex Formula Compound
(b) Dewatering the excess treating solution from said cellulose textile;
(c) curing said dried cellulose textile;
(d) washing said cured cellulose textile to remove excess reagents;
(e) drying said cellulose textile to remove water; and thereby preparing a anti-microbial cellulose textile.

In this present inventors, Formular-A (Chitosan and chitin) are polysaccharide polymers containing more than 5,000 glucosamine and acetylglucosamine units, respectively, and their molecular weights are over one million Daltons. Chitin is found in fungi, arthropods and marine invertebrates. Commercially, chitin is derived from the exoskeletons of crustaceans (shrimp, crab and other shellfish). Chitosan is obtained from chitin by a deacetylation process.

In this present inventors, Formular-B

Hydantoin, Heterocyclic N-halamines suitable for use in accordance with the present invention include, but are not limited to, the following: the product of monomethylol-5,5-dimethylhydantoin (MDMH),
1,3-dimethylol-5,5-dimethylhydantoin (DMDMH);
monomethylolated and dimethylolated derivatives of
2,2,5,5-tetramethyl-1,3-imidazolidin-4-one,
6,6-dimethyl-1,3,5-triazine-2,4-dione,
4,4,5,5-tetramethyl-1,3-imidazolidin-2-one,
cyanuric acid and 5,5-dimethylhydantoin; and monomethyloxylated and dimethoxylated derivatives of monomethylolated and dimethylolated derivatives of 6,6-dimethyl-1,3,5-triazine-2,4-dione, 4,4,5,5-tetramethyl-1,3-imidazolidin-2-one, cyanuric acid, 5,5-dimethylhydantoin and 2,2,5,5-tetramethyl-1,3-imidazolidin-4-one.
   Examples of the monomethoxylated and dimethoxylated compounds are monomethoxymethyl-5,5-dimethylhydantoin and 1,3-dimethoxymethyl-5,5-dimethylhydantoin, respectively. In a presently preferred embodiment, monomethylol-5,5-dimethylhydantoin and 1,3-dimethylol-5,5-dimethylhydantoin.

Hydantoin, Heterocyclic N-halamines used in the present invention are commercially available from a number of different sources. For instance, monomethylol-5,5-dimethylhydantoin (MDMH) and 1,3-dimethylol-5,5-dimethylhydantoin (DMDMH) are commercially available under the tradenames DANTOIN.RTM. In addition, those of skill in the art will readily appreciate that the heterocyclic N-halamines used in the present invention can be synthesized in a variety of ways using conventional synthetic chemistry techniques. In this connection, those of skill will readily appreciate that the dimethoxylated derivatives are prepared from the dimethylated derivatives, whereas the monomethoxylated derivatives are prepared from either the mono- or dimethylated derivatives.

In this present inventors, Formular-B

Quaternary ammonium salt, is a member selected from the group consisting of:
dodecyltrimethyl ammonium bromide,
N-(3-chloro-2-hydroxypropyl)-N,N-dimethyldodecylammonium chloride,
1,3-Bis-(N,N-dimethyldodecylammonium chloride)-2-propanol,
dodecyltrimethyl ammonium chloride,
N-(1-(2,3-dioleoyloxy)propyl)-N,N,N-trimethylammonium chloride,
N-(1-(2,3-dioleyloxy)propyl)-N,N,N-trimethylammonium chloride,
dimethyldioctadecyl ammonium bromide,
N,N-dioleyl-N,N-dimethylammonium chloride and
1,2-dioleoyloxy-3-(N,N,N-trimethylamino)propane chloride.

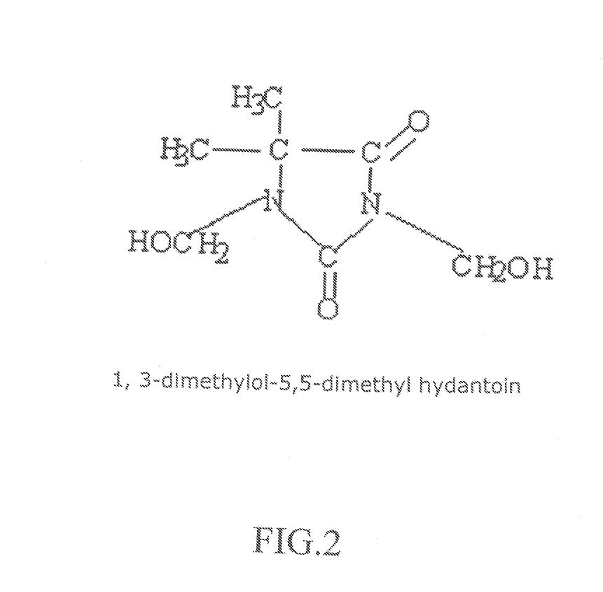

Examples of the hydantoin, heterocyclic N-halamines suitable for use in some applications are set forth in FIG. 2. It should be noted that many of these hydantoin, heterocyclic N-halamines are widely used in cosmetic products and they are major disinfectants for use in, for example, swimming pools. As such, these compounds will not generate any toxic effects for humans or for the environment either in terms of the finished fabric or during the finishing process.

“Anti-microbial,” as used herein, refers to the ability to kill at least some types of microorganisms, or to inhibit the growth or reproduction of at least some types of microorganisms. The textiles prepared in accordance with the present invention have Anti-microbial activity against a broad spectrum of pathogenic microorganisms. For example, such textiles have Anti-microbial activity against representative gram-positive (such as Staphylococcu aureus) and gram-negative bacteria (such as Escherichia coli). Moreover, the Anti-microbial activity of such textiles is readily regenerable.

In step (a) of the above process, the aqueous curing solution comprises a Complex Formula Compounds as described above.

Those of skill in the art will readily appreciate that the concentration of the various components of the aqueous curing solution can be widely varied depending upon the particular components employed and the results desired. Typically, the Complex Formula Compounds is present at a concentration of at least about 1.0%. More typically, the Complex Formula Compounds is present at a concentration ranging from about 1.0% to about 20%, more preferably at a concentration ranging from about 1.0% to about 10% and, more preferably at a concentration ranging from about 1.0% to about 5.0%. It will be readily apparent to those of skill in the art that higher Complex Formula Compounds concentrations can be employed, but such higher concentrations are not required to impart Anti-microbial activity. Again, suitable Anti-microbial activity can be imparted using a Complex Formula Compounds concentration as low as about 1.0%. The pH of the aqueous treating solution will typically range from a pH of about 2 to about 6 and, more preferably, from a pH of about 2.5 to about 4.0.

Those of skill in the art will readily appreciate that other additives can be incorporated into the aqueous curing solution to impart favorable characteristics to the cellulose, cellulose/polyester or polyester textile. Such additives can include softeners and waterproofing agents which are known to and used by those of skill in the art. Examples of softeners which can be added to the aqueous treating solution include, which are commercially available.

Examples of waterproofing agents which can be added to the aqueous treating solution include, and other water repellent finishing solutions used by those of skill in the art.

In carrying out step (a), the textile used may be roving, yarn or fabric regardless of whether spun, knit, or woven, or may be no woven sheets or webs. Moreover, the textile may be made of cellulose fibers, polyester fibers or blends of these. In addition, other polymer materials having reactive functional groups (—OH groups) can be used. Such polymer materials include, but are not limited to, polyvinyl alcohol (PVA), starches and proteins. In wetting the textile in the finshing or treating bath, ordinary textile equipment and methods suitable for batchwise or continuous passage of roving, yarns or fabrics through an aqueous solution may be used, at any speed permitting thorough and uniform wetting of the textile material.

In step (b), the excess aqueous treating solution is dewatering by ordinary mechanical methods such as by passing the textile between squeeze rolls, by centrifugation, by draining or by padding. In a preferred embodiment, the excess aqueous treating solution is removed by padding.

In step (c), the cellulosic, cellulosic/polyester or polyester textile is curing at a temperature ranging from about 135 degree C. to about 165 degree C. and, more preferably, at a temperature ranging from about 100 degree C. to about 185 degree C. for a period of time ranging from about 1 to about 8 minutes and, more preferably, for about 5 minutes. The heating can be carried out in an oven, preferably one having a forced draft of air directed at the surface of the textile and exhausting through a vent to remove fumes.

In step (d), the dried cellulosic, cellulosic/polyester or polyester textile is washed. Washing of the treated textile, step (d), may be done with either hot or cold water. The covalent bonds formed are stable, insoluble, and durable to the mechanical agitation, spraying and rubbing that occurs in washing machines or in large scale continuous or batchwise textile washing equipment.

Final drying, step (e), can be carried out by any ordinary means such as oven drying, line drying or turnable drying in a mechanical clothes dryer. A drying temperature of about 80 degree to about 120 degree C. for about 1 to about 5 minutes is particularly preferred.

In another embodiment, the present invention provides a process for rendering a cellulosic, cellulosic/polyester or polyester textile Anti-microbial the process comprising:
(a) washing a Anti-microbial cellulosic, cellulosic/polyester or polyester textile precursor with a halogenated solution, the Anti-microbial textile precursor being prepared in accordance with the above method; and
(b) drying the treated Anti-microbial cellulosic, cellulosic/polyester or polyester textile to remove water. In the process, the halogenated solution can be a chlorine solution or, alternatively, a bromine solution. In a presently preferred embodiment, the halogenated solution is a chlorine solution (e.g., a chlorine bleach solution such as CLOROX.RTM.). The washing of the Anti-microbial cellulosic, cellulosic/polyester or polyester textile precursor with a halogenated solution renders the textile biocidal and, in addition, it sterilizes the textile. Moreover, as previously explained, the Anti-microbial activity, i.e., oxidative properties, of the textiles can be regenerated by periodically washing the textile with a halogenated solution during regular washings.

In yet another embodiment, the present invention provides a composition for finishing fabrics, the composition comprising a Complex Formula Compounds. In a preferred embodiment, the composition further includes additives (e.g., softeners and waterproofing agents) to impart favorable characteristics.

The discussions pertaining to the Complex Formula Compounds, additives and their various concentrations are fully applicable to this composition and, thus, such discussions will not be repeated again. The pH of the aqueous treating solution will typically range from a pH of about 2.0 to about 6 and, more preferably, from a pH of about 2.5 to about 4.5. Those of skill in the art will readily appreciate that the above composition can be prepared in a concentrated form or, alternatively, in a form suitable for immediate use, i.e., at appropriate reagent concentrations.

Considering both antibacterial and mechanical properties of the finished textiles prepared using the methods and compositions set forth herein, those of skill will readily appreciate that such finished textiles can advantageously be used in the preparation of the following articles: surgeon's gowns, caps, masks, surgical cover, patient drapes, carpeting, bedding materials, underwear, socks, uniforms, etc. Those of skill in the art will readily appreciate that the finished textiles of the present invention can also advantageously be used for a variety of other purposes, such as in hotel-use towels, bedding materials, hygienic products, in various clothing to protect against pesticides and other toxic chemicals, etc.

The invention will be described in greater detail by way of specific examples. The following examples are offered for illustrative purposes, and are intended neither to limit or define the invention in any manner.

### EXAMPLES

### Example I

This example illustrates the finishing of fabrics with Chitosan, monomethylol-5,5-dimethythydantoin (MDMH).

A finishing bath containing 16 grams of Chitosan (10.0%), 24 grams of monomethylol-5,5-dimethylhydantoin, (55%) in 800 milliliters of deionized water was prepared. The pH of the finishing bath was adjusted to 3.0 with one milliliter of 0.1 N HCl solution. Then, 150 grams of pure cotton fabric (X-011) and 150 grams of cotton/polyester (35/65) blend fabric (X-012) were dipped in the bath for more than two minutes and padded through a padder with a more than 65% pick-up rate. The fabrics were dipped and padded again, and dried at 80 degree C. for 3 minutes. The fabrics were then cured at 160 degree C. for 2 minutes. Finally, the finished fabrics were machine washed with 300 grams Detergent at a low water level and a temperature of about 60 degree C. for 20 minutes. The fabrics were dried and weighed, yielding 31.7 grams (1.00% add-on) of the cotton fabric and 240.6 grams (1.2% add-on) of the cotton/polyester blend fabric.

Antibacterial properties of the fabrics were tested against representative gram-positive (such as Staphylococcu aureus (ATCC 5368)) and gram-negative bacteria (such as Escherichia coli (ATCC 2666)) using the protocol set forth in Example III.

### Example II

This example illustrates the finishing of fabrics with Chitosan, 1,3-dimethylol-5,5-dimethylhydantoin (DMDMH).

A finishing bath containing 32 grams of Chitosan, 48 grams of 1,3-dimethylol-5,5-dimethylhydantoin (DMDMH), in 1200 milliliters of deionized water was prepared. The pH of the finishing bath was adjusted to 3.0. Then, 180 grams of pure cotton fabric (X-011) and 180 grams of cotton/polyester (35/65) blend fabric (X-012) were dipped in the bath for more than five minutes and padded through a padder with more than an 70% pick up rate. The fabrics were then cured at 160 degree C. for 2 minutes. Finally, the finished fabrics were machine washed with Detergent at a low water level and a temperature of about 60 degree C. for 30 minutes. The fabrics were dried and weighed, yielding 100 grams (1.5% add-on) of the cotton fabric and 145.5 grams (1.62% add-on) of the cotton/polyester blend fabric.

Antibacterial properties of the fabrics were tested against representative gram-positive (such as Staphylococcu aureus (ATCC 5368)) and gram-negatibe bacteria (such as Escherichia coli (ATCC 2666)) using the protocol set forth in Example III.

### Example III

This example illustrates the qualitative antibacterial study of the Example I finished fabrics carried out using the AATCC Test Method 147.

Fabric samples of X-011 and X-012 were finished in a manner similar to that set forth in Example I. The concentration of the finishing agent used was from about 5 to 10% in the finishing of the cotton fabrics and from about 5 to 15% in the finishing of the cotton/polyester (35/65) blend fabric because of the lower concentration of cellulose in the blend. The final biocidal property was imparted onto the finished fabrics. Qualitative antibacterial tests were conducted according to AATCC Test Method 147.

In the AATCC Test Method 147, two pieces of chlorinated fabrics with the size of 25 mm.times.50 mm were placed on a nutrient agar plate which had been inoculated by five streaks of a diluted bacteria solution using a 4 mm inoculating loop. The diluted bacteria solution was prepared by transferring 1.0 milliliter of 24 hour broth culture into 9.0 milliliter of sterile distilled water. The agar plate was incubated at 37 degree C. for 18-24 hours. The minimum width of inhibition zone along a streak on either side of the test specimen are measured. Table I sets forth the qualitative biocidal evaluations of the finished fabrics with different concentration of the agent Anti-1. Even with a 5% finishing agent concentration and about a 1% add-on of the agents, the processed fabrics exhibit durable and regenerable antibacterial properties.

TABLE I
Results of Finished Cotton (X-011) and Cotton/Polyester 35/65 (X-012)

| | | | Biocidal Results* | | Biocidal Results | | |
|---|---|---|---|---|---|---|---|
| | | | After 20 | | After 50 | | |
| Conc. of | | | Times Washing | | Times Washing | | |
| Fabric | Add-on chitosan | % | E. coli | S. aureus | E. coli | S. aureus | |
| X-011 | 5 | 1.2 | >3 mm | >1 mm | >1 mm | about 1 | mm |
| | 10 | 2.3 | >8 mm | >3 mm | >3 mm | >1 | mm |
| | 15 | 3.1 | kill all | kill all | >4 mm | >4 | mm |
| X-012 | 5 | 0.8 | >3 mm | >1 mm | >1 mm. | about 1 | mm |
| | 10 | 1.4 | >3 mm | >1 mm | >2 mm. | about 1 | mm |
| | 15 | 1.6 | kill all | kill all | >2 mm | >1 | mm |
| | 20 | 2.0 | kill all | >4 mm | >3 mm | >1 | mm |

*Biocidal results were tested with AATCC test method 147, the minimum disinfection distance is measured in millimeter (mm). Washing tests were conducted with machine wash warm according to AATCC test method 124 and AATCC Standard Reference Detergent 124 was used.

### Example IV

Four types of clothing materials, i.e., X-011, Terry cloth and Rayon, were chemically finished with the functional agent following the protocol set forth in Example I. The antibacterial results of the different fabrics finished with Chitosan and (MDMH) are shown in Table II. The percentage of add-on of functional agents by the fabrics was only about 1%. However, after activation of the biocidal properties of fabrics, the zones of inhabitation of bacteria were relatively large. The results indicate that the cellulose-containing materials can easily incorporate with the functional finishing agents and obtain the desired function against microorganisms in a broad spectrum. If complete disinfection is required, the add-on rate of the finishing agents could be increased by increasing the concentration of the agents as discussed above. However, in most applications, only appropriate biocidal properties are needed.

TABLE II
Antibacterial Results of Different Fabrics
Finished with Chitosan and MDMH

| | | Biocidal results | Biocidal results |
|---|---|---|---|
| | | against S. aureus | against E. coli |
| | % Add-on | after being | after being |
| Fabrics | of the agent | activated (mm) | activated (mm) |
| Cotton cloth | 1.43 | >1.0 | >2.0 |
| X-011 | | | |
| Rayon | 1.21 | >1.0 | >1.0 |
| Dacron/Cotton 65/3 | 1.19 | >4.0 | >10 |
| X-012 | | | |
| Terry cloth | 1.40 | kill all | >10 |
| 100% Cotton | | | |
| Control Cotton | — | all grow | all grow |
| #400 | | | |

### Example V

The example illustrates the quantitative antibacterial study (AATCC Test Method 100) of Anti-1 finished fabrics.

Quantitative studies of biocidal properties of the Chitosan and MDMH finished fabrics indicates that even at a very low concentration of the finishing bath, biocidal properties on fabrics can be obtained. AATCC Test Method 100 was adopted in this study. According to this test method, four pieces of staked circular fabric swatches 4.8.+−.0.1 (about one grams) were inoculated with 1.0.+−.0.1 milliliter of inoculum in a 250 milliliter jar. The inoculum was a nutrient broth culture containing over 1.0.times.10.sup.6 clone forming units (CFU) of organisms. After the swatches were inoculated, they were neutralized by 100 milliliter of a 0.02% sodium thiosulfate solution in the jar. The contact time was the time between inoculation and neutralization. The jar was vigorously shaken and the neutralized solution was diluted in serial. The dilutions, usually 10.sup.0, 10.sup.1, and 10.sup.2, were plated on nutrient agar and incubated for 18-24 hours at 37 degree C. The number of bacteria recovered from the inoculated finished fabrics was counted and compared with that from untreated fabrics. Six log reduction means the total inactivation of bacteria, and one log reduction means that finished fabrics reduced bacteria counts from 10.sup.6 CFU to 10.sup.5 CFU. Finished fabrics prepared from solutions containing 1%-6% of monomethylol-5,5-dimethylhydantoin following the protocol set forth in Example I with pickup rates below 1% have been tested. The biocidal properties of such fabrics are set forth in Table III.

TABLE III
Effects of Finishing Concentrations of Chitosan/MDMH on Bacterial Reduction Rates.

| | | Bacterial reduction rates on contact time | | | | | |
|---|---|---|---|---|---|---|---|
| Conc. of | Take up | 0 min | | 30 min | | 60 min | |
| Agent Material | % | E. coli | S. aureus | E. coli | S. aureus | E. coli | S. aureus |
| 1% X-011 | 0.65 | No | No | No | 1 log | No | No |
| X-012 | 0.14 | No | No | 1 log | No | 1 log | No |
| 2% X-011 | 0.03 | No | 1 log | 6 log | 6 log | 6 log | 6 log |
| X-012 | 0.07 | No | No | 6 log | 1 log | 6 log | 6 log |
| 4% X-011 | 0.47 | 6 log | 6 log | 6 log | 6 log | 6 log | 6 log |
| X-012 | 0.45 | 6 log | 6 log | 6 log | 6 log | 6 log | 6 log |
| 6% X-011 | 0.70 | 6 log | 6 log | 6 log | 6 log | 6 log | 6 log |
| X-012 | 0.70 | 6 log | 6 log | 6 log | 6 log | 6 log | 6 log |

X-011 is 100% cotton plain woven fabric and X-012 is a (65/35)
Polyester cotton plain woven fabric.
Six log reduction means total kill.

### Example VI

This example illustrates the quantitative antibacterial study (AATCC Test Method 100) of Chitosan and DMDMH finished fabrics.

Fabrics finished in accordance with the protocol set forth in Example II with Chitosan, i.e., 1,3-dimethylol-5,5-dimethylhydantoin, were also tested with AATCC test method 100, which was briefly described in Example IV. In the tests, The biocidal properties of Chitosan and DMDMH finished fabrics are set forth in Table V.

TABLE V
Durable Antibacterial Properties of Chitosan/DMDMH Finished Fabrics

| | After five | | After ten | | After fifteen | | After twenty | | After twenty | |
|---|---|---|---|---|---|---|---|---|---|---|
| Conc | washes | | washes | | washes | | washes | | washes | |
| of | E. coli | S. aur. | E. coli | S. aur. | E. col | S. aur. | E. coli | S. aur. | E. coli | S. aur. |
| 2% X-011 | 6 log | 6 log | 6 log | 6 log | 6 log | 6 log | 6 log | 6 log | 6 log | 6 log |
| X012 | 6 log | 6 log | 6 log | 6 log | 6 log | 6 log | 6 log | 6 log | 6 log | 6 log |
| 6% X-011 | 6 log | 6 log | 6 log | 6 log | 6 log | 6 log | 6 log | 6 log | 6 log | 6 log |
| X-012 | 6 log | 6 log | 6 log | 6 log | 6 log | 6 log | 6 log | 6 log | 6 log | 6 log |
| 10% X-011 | 6 log | 6 log | 6 log | 6 log | 6 log | 6 log | 6 log | 6 log | 6 log | 6 log |
| X-012 | 6 log | 6 log | 6 log | 6 log | 6 log | 6 log | 6 log | 6 log | 6 log | 6 log |

X-011 is 100% cotton plain woven fabric and X-012 is a (65/35)
Polyester cotton plain woven fabric.
Contact time = 60 min.
Six log reduction means total kill of bacteria.
Zero log reduction means some reduction of bacterial growth and extended contact causes further reduction.
Washing test were following AATCC124 using machine washing warm (140.degree. C.) for 15 min.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A process for preparing a anti-microbial cellulose textile with a Complex Formula Compounds, said process comprising:
(a) wetting a cellulose textile in an aqueous treating solution which comprises a anti-microbial Complex Formula Compound
(b) dewatering the excess treating solution from said cellulose textile;
(c) curing said dried cellulose textile;
(d) washing said cured cellulose textile to remove excess reagents;
(e) drying said cellulose textile to remove water; and thereby preparing a anti-microbial cellulose textile.

2. The process of claim 1 wherein said cellulose textile is: cotton, wool, silk, down, feather, wood-Paul fabric.

3. The process of claim 2 wherein said cellulose textile is a member selected from the group consisting of fabric, yarn and fiber.

4. The process of claim 1 wherein said Complex Formula Compound consists: Formula-A and Formula-B.

5. The process of claim 4 wherein said Formula-A is a member selected from the group consisting of: Chitosan, Chitin.-Chitin, the polysaccharide polymer from which chitosan is derived, is a cellulose-like polymer consisting mainly of entrenched chains of N-acetyl-D-glucosamine, Deacetylated chitin, or chitosan, is comprised of chains of D-glucosamine.

6. The process of claim 4 wherein said Formula-B is a member selected from the group consisting of: Hydantoin chemistry, Heterocyclic N-halamine, and Quaternary ammonium salt.
Hydantoin chemistry, Heterocyclic N-halamine, is a member selected from the group consisting of
monomethylol-5,5-dimethylhydantoin (MDMH),
1,3-dimethylol-5,5-dimethylhydantoin (DMDMH);
monomethylolated and dimethylolated derivatives of
2,2,5,5-tetramethyl-1,3-imidazolidin-4-one,
6,6-dimethyl-1,3,5-triazine-2,4-dione,
4,4,5,5-tetramethyl-1,3-imidazolidin-2-one, cyanuric acid and
5,5-dimethylhydantoin; and monomethoxylated and dimethoxylated derivatives of monomethylolated and dimethylolated derivatives of 6,6-dimethyl-1,3,5-triazine-2,4-dione, 4,4,5,5-tetramethyl-1,3-imidazolidin-2-one, cyanuric acid, 5,5-dimethylhydantoin, 2,2,5,5-tetramethyl-1,3-imidazolidin-4-onemonomethylol-5,5-dimethylhydantoin (MDMH).
Quaternary ammonium salt, is a member selected from the group consisting of: dodecyltrimethyl ammonium bromide, N-(3-chloro-2-hydroxypropyl)-N,N-dimethyldodecylammonium chloride, 1,3-Bis-(N,N-dimethyldodecylammonium chloride)-2-propanol, dodecyltrimethyl ammonium chloride, N-(1-(2,3-dioleoyloxy)propyl)-N,N,N-trimethylammonium chloride, N-(1-(2,3-dioleyloxy)propyl)-N,N,N-trimethylammonium chloride, dimethyldioctadecyl ammonium bromide, N,N-dioleyl-N,N-dimethylammonium chloride and 1,2-dioleoyloxy-3-(N,N,N-trimethylamino)propane chloride.
